(19) United States
(12) Patent Application Publication
(10) Pub. No.: US 2020/0288903 A1
(43) Pub. Date: Sep. 17, 2020

(54) SEALING GASKET WITH TWO DEFORMATION SPACES

(71) Applicant: Ming-Tung LIU, Taipei City (TW)

(72) Inventor: Ming-Tung LIU, Taipei City (TW)

(21) Appl. No.: 16/439,823

(22) Filed: Jun. 13, 2019

(30) Foreign Application Priority Data
Mar. 15, 2019 (TW) 108108922

(51) Int. Cl. A47J 31/44; F16J 15/02

(52) U.S. Cl. CPC A47J 31/4403; F16J 15/024

(57) ABSTRACT

A sealing gasket with two deformation spaces is configured to be mounted in a cup-shaped structure and has a through bore that opens on the top and bottom sides of the sealing gasket. The sealing gasket is characterized in that: an inner deformation space and an outer deformation space extend downward into the top side of the sealing gasket, the inner deformation space is adjacent to the through bore such that an inner deformable portion is formed between the inner deformation space and the through bore, and the outer deformation space is adjacent to the outer wall of the sealing gasket such that the outer wall forms an outer deformable portion corresponding to the outer deformation space. The two deformation spaces provide the sealing gasket with enhanced deformability to adapt to a through hole whose diameter may vary within engineering tolerances.

### FIELD OF THE INVENTION

The present invention relates to a sealing gasket and more particularly to a sealing gasket with two deformation spaces.

### BACKGROUND OF THE INVENTION

Drinks such as coffee and tea contain a lot of wholesome ingredients. For example, a tea infusion may include carbohydrates, proteins, free amino acids, fatty acids, polyphenols, organic acids, plant alkaloids, minerals, and so on, whereas brewed coffee may include caffeine, antioxidants, polyphenols, proteins, tannins, linoleic acid, plant alkaloids, and so forth. This explains why many people like to have a cup of coffee or tea during or after work to either refresh themselves or stay in good health.

In light of this, the inventor of the present invention developed a portable brewing container that allows its user to brew coffee or tea rapidly wherever desired, as described below with reference to FIG. 1 and FIG. 2. The brewing container 1 is composed of a cup-shaped structure 11, a sealing gasket 13, a liquid-stopping disk 15, and a liquid stopper 17. The cup-shaped structure 11 includes a receiving space 10 extending downward into its top side and has a through hole 111 in its bottom side. The sealing gasket 13 is mounted in the cup-shaped structure 11 at a position corresponding to the through hole 111. The sealing gasket 13 has a through bore 130 configured to communicate with the receiving space 10 so that the liquid in the receiving space 10 can flow out through the through bore 130. The liquid-stopping disk 15 is mounted on a bottom portion of the cup-shaped structure 11, can be moved vertically, and is provided with a post 151 and a plurality of openings 153. The post 151 is configured to extend into the through bore 130, and the openings 153, to communicate with the through bore 130. The liquid stopper 17 is placed in the cup-shaped structure 11 and fixed on a top portion of the post 151. The largest diameter of the liquid stopper 17 is larger than the diameter of the through bore 130.

When the liquid-stopping disk 15 falls freely under gravity, referring again to FIG. 1 and FIG. 2, the liquid stopper 17 is driven downward by the post 151 and ends up covering the entire through bore 130, preventing the liquid in the cup-shaped structure 11 from flowing out. When the liquid-stopping disk 15 is pushed upward, e.g., when the cup-shaped structure 11 together with the liquid-stopping disk 15 is placed on a tea cup, the liquid stopper 17 is driven upward by the post 151 and therefore no longer covers the through bore 130; consequently, the liquid in the cup-shaped structure 11 is allowed to flow into the tea cup sequentially through the through bore 130 and the openings 153 in order to be drunk. When the cup-shaped structure 11 is mass-produced, however, the diameter of the through hole 111 may vary from one cup-shaped structure 11 to another as the type of the end product varies or as is allowed in the manufacturing process (i.e., when certain manufacturing tolerances apply). Variation in diameter of the through hole 111 may prevent the wall of the through hole 111 from abutting tightly against the sealing gasket 13 mounted in the cup-shaped structure 11, and should that happen, the liquid in the cup-shaped structure 11 will leak through the gap between the sealing gasket 13 and the wall of the through hole 111, meaning the sealing effect of the sealing gasket 13 is compromised.

Moreover, in order to achieve a tight fit between the sealing gasket 13 and the liquid stopper 17 in FIG. 1, the inventor designed the two sealing gasket configurations in FIG. 2 and FIG. 3. The sealing gasket 13 in FIG. 2 is provided with a thin annular plate 131, which protrudes upward from the top side of the sealing gasket 13 and is adjacent to the through bore 130. When the liquid stopper 17 abuts against the top side of the sealing gasket 13, the thin annular plate 131 is deformed to lie compliantly against the periphery of the liquid stopper 17. The sealing gasket 23 in FIG. 3 is provided with a groove 233, which extends into the top side of the sealing gasket 23 and is adjacent to the through bore 230 such that a thin annular plate 231 is formed. When the liquid stopper 17 abuts against the top side of the sealing gasket 23, the thin annular plate 231 will also be deformed to lie compliantly against the periphery of the liquid stopper 17. The relatively small thicknesses and lengths of the thin annular plates 131 and 231, however, make it extremely difficult to unmold those plates during manufacture (with the exceptionally narrow groove 233 presenting the greatest difficulty in unmolding), which not only prolongs the manufacturing process, but also hinders the improvement of product yield. Besides, the thin annular plates 131 and 231 break easily during use or the unmolding process and, once broken, cannot produce the intended effect.

According to the above, the existing sealing gaskets still leave much to be desired. For those who are involved in the design and manufacture of sealing gaskets, therefore, it is important, or even critical to their survival in the industry, to overcome the foregoing drawbacks.

### BRIEF SUMMARY OF THE INVENTION

In view of the various problems of the conventional sealing gaskets during manufacture and use, the inventor of the present invention conducted an extensive research and repeated experiments and finally succeeded in developing a sealing gasket that has two deformation spaces to effectively overcome the drawbacks of the prior art.

One objective of the present invention is to provide a sealing gasket that has two deformation spaces. The sealing gasket is configured to be mounted in a cup-shaped structure and has a main body penetrated by a through bore. The through bore opens on the top side and the bottom side of the main body. An inner deformation space extends downward into the top side of the main body and is adjacent to the through bore such that an inner deformable portion is formed between the inner deformation space and the through bore. An outer deformation space extends downward into the top side of the main body and is adjacent to the outer wall of the main body such that the outer wall of the main body forms an outer deformable portion corresponding to the outer deformation space. The two deformation spaces provide the sealing gasket with enhanced deformability so that the sealing gasket can adapt to a through hole whose diameter may vary within manufacturing tolerances.

### BRIEF DESCRIPTION OF THE SEVERAL VIEWS OF THE DRAWINGS

The objectives, technical features, and effects of the present invention can be better understood by referring to the following detailed description of some illustrative embodiments in conjunction with the accompanying drawings, in which:

FIG. 1 is an exploded perspective view of a conventional brewing container;

FIG. 2 is a sectional view of a conventional sealing gasket;

FIG. 3 is a sectional view of another conventional sealing gasket;

FIG. 4 is an exploded perspective view of a brewing container to which the present invention is applied;

FIG. 5 is a perspective view of the sealing gasket in FIG. 4; and

FIG. 6 is a sectional view of the sealing gasket in FIG. 5.

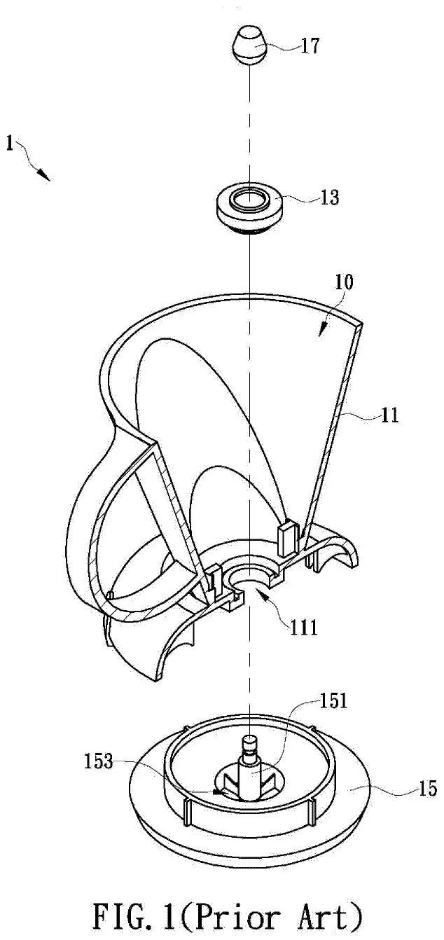

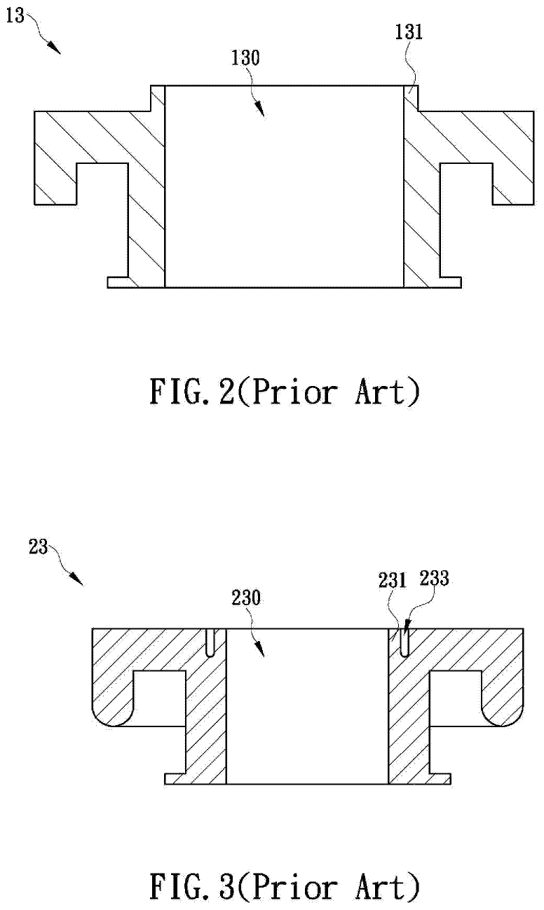

### DETAILED DESCRIPTION OF THE INVENTION

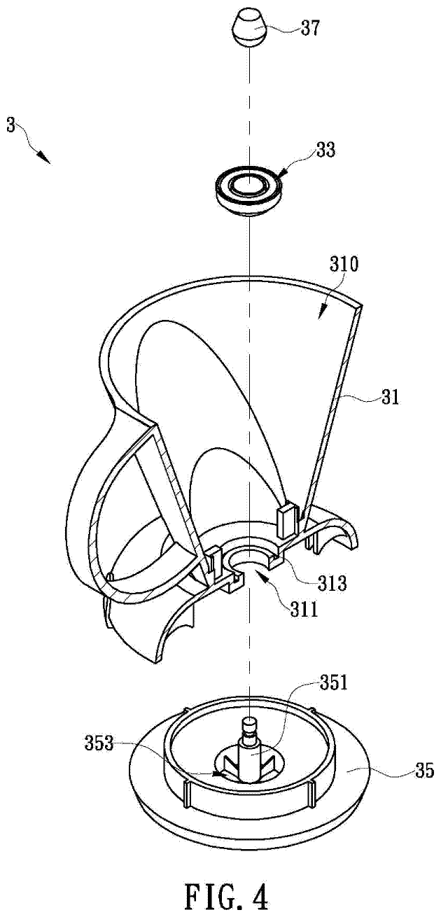

The present invention provides a sealing gasket that has two deformation spaces. Referring to FIG. 4, the sealing gasket 33 according to an embodiment of the invention is configured to be mounted in the cup-shaped structure 31 of a brewing container 3, wherein the cup-shaped structure 31 is provided therein with a receiving space 310 and has a through hole 311 in the bottom side, and wherein the through hole 311 is in communication with the receiving space 310. More specifically, the sealing gasket 33 is configured to be mounted in the cup-shaped structure 31 at a position corresponding to the through hole 311. A liquid-stopping disk 35 is vertically movably mounted on a bottom portion of the cup-shaped structure 31 and is provided with a post 351 and a plurality of openings 353, wherein the post 351 is configured to extend into the receiving space 310 through the sealing gasket 33. A liquid stopper 37 is configured to be placed in the cup-shaped structure 31 and fixed on the top end of the post 351 in order to be pushed by the post 351. The liquid stopper 37 may be spherical.

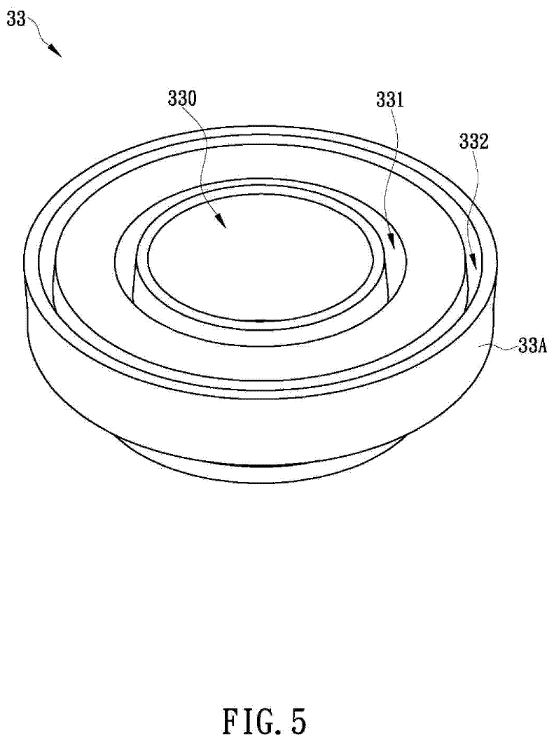

As shown in FIG. 4 to FIG. 6, the sealing gasket 33 has a main body 33A with a through bore 330. The through bore 330 opens on the top side and the bottom side of the main body 33A. Once the sealing gasket 33 is mounted in the cup-shaped structure 31, the through bore 330 is in communication with the receiving space 310 so that the liquid in the receiving space 310 can flow out through the through bore 330. The post 351 of the liquid-stopping disk 35 is configured to extend into the receiving space 310 through the through bore 330. The largest diameter of the liquid stopper 37 is larger than the diameter of the through bore 330 in order for the liquid stopper 37 to cover the top portion of the through bore 330 and thereby prevent the liquid in the receiving space 310 from flowing into the through bore 330, and when the liquid stopper 37 is pushed away from the through bore 330 by the post 351, the liquid in the receiving space 310 is allowed to flow sequentially through the through bore 330 and the openings 353.

With continued reference to FIG. 4 to FIG. 6, an inner deformation space 331 extends downward into the top side of the main body 33A and is adjacent to the through bore 330. The inner deformation space 331 and the through bore 330 form an inner deformable portion 333 therebetween. When the liquid stopper 37 falls on the top portion of the through bore 330, the inner deformable portion 333 will be deformed to conform to and lie against the periphery of the liquid stopper 37, thereby producing a watertight sealing effect. An outer deformation space 332 also extends downward into the top side of the main body 33A and is adjacent to the outer wall of the main body 33A such that the outer wall of the main body 33A forms an outer deformable portion 334 corresponding to the outer deformation space 332. If the through hole 311 of the cup-shaped structure 31, in which the sealing gasket 33 is to be mounted, has a relatively small diameter within manufacturing tolerances, the outer deformation space 332 will allow the outer deformable portion 334 to be displaced toward the outer deformation space 332, so the sealing gasket 33 can still be mounted properly in the cup-shaped structure 31. Thanks to the inner deformation space 331 and the outer deformation space 332, the sealing gasket 33 can be deformed (or more specifically compressed) to a greater extent than without those deformation spaces.

In this embodiment, referring again to FIG. 4 to FIG. 6, the side of the outer deformable portion 334 that faces away from the outer deformation space 332 (i.e., the outer wall of the outer deformable portion 334) is inclined, and the top end of this inclined side is farther away from the central axis L of the main body 33A than is the bottom end of the same side. This design allows the sealing gasket 33 to better match the diameter of the through hole 311 because, regardless of the permissible dimensional deviations of the through hole 311, the outer deformable portion 334 will always be able to lie compliantly against the wall of the through hole 311 to provide the intended watertightness. In other embodiments of the present invention, however, the aforesaid side of the outer deformable portion 334 may be parallel to the central axis L of the main body 33A instead. The side of the inner deformable portion 333 that corresponds to the inner deformation space 331 is also inclined, and the top end of this inclined side is closer to the central axis L of the main body 33A than is the lower end of the same side. In cases where the wall of the through bore 330 is parallel to the central axis L, this structural design renders the top end of the inner deformable portion 333 thinner than the bottom end so that the inner deformable portion 333 can deform, and lie compliantly against the periphery of the liquid stopper 37, more easily than otherwise. Moreover, the relatively thick bottom end of the inner deformable portion 333 makes the inner deformable portion 333 less vulnerable to breaking (than the thin annular plate in the prior art) and therefore contributes to increasing the service life of the sealing gasket 33.

With continued reference to FIG. 4 to FIG. 6, although the sealing gasket 33 may expand or shrink in response to temperature variations, the inner deformation space 331, the outer deformation space 332, and the foregoing inclined sides help ensure the watertight sealing effect of the sealing gasket 33. For example, when the sealing gasket 33 contracts under a low temperature, the inclined side of the outer deformable portion 334 will still lean outward and lie compliantly against the wall of the through hole 311 to prevent the formation of gaps. When the sealing gasket 33 expands under a high temperature, the deformation spaces 331, 332 and the deformable portions 333, 334 can be deformed to adapt to the expansion. Furthermore, the inner deformation space 331 in this embodiment is wider at the top end than at the bottom end, and so is the outer deformation space 332. This configuration is intended to facilitate unmolding of the sealing gasket 33 during manufacture and thereby lower the fraction defective of the sealing gasket 33.

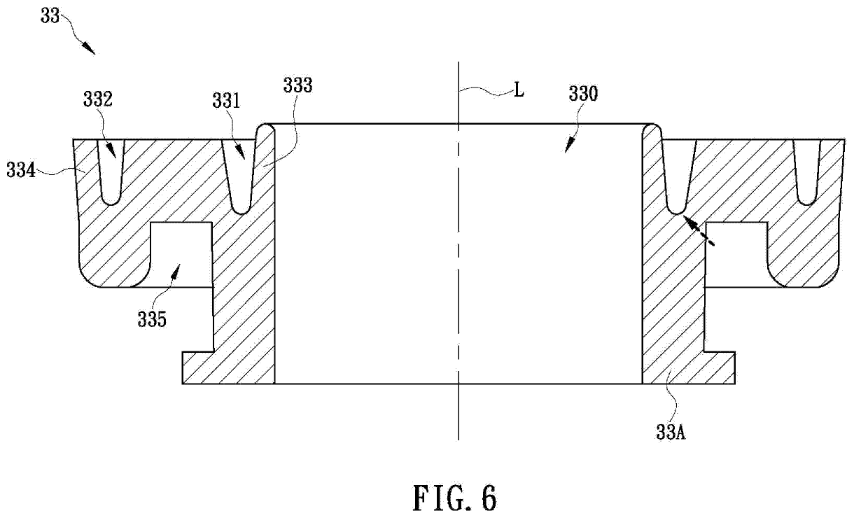

With continued reference to FIG. 4 to FIG. 6, the main body 33A in this embodiment is peripherally provided with an engaging portion 335 adjacent to the bottom side of the main body 33A. The engaging portion 335 is configured to engage with an engaging member 313 of the cup-shaped structure 31 so that, when thermal contraction or expansion takes place or when manufacturing tolerances come into play, an area adjacent to the engaging portion 335 can be pushed toward the inner deformation space 331 (as indicated by the dashed-line arrow in FIG. 6) to affect only the size of the inner deformation space 331 while the inner deformable portion 333 (in particular its top end) remains generally at its predetermined position without moving excessively toward the central axis L and therefore keeps lying compliantly against the liquid stopper 37.

While the invention herein disclosed has been described by means of specific embodiments, numerous modifications and variations could be made thereto by those skilled in the art without departing from the scope of the invention set forth in the claims.

What is claimed is:

1. A sealing gasket with two deformation spaces, configured to be mounted in a cup-shaped structure, the sealing gasket comprising:
a main body with a through bore, wherein the through bore opens on a top side and a bottom side of the main body;
an inner deformation space extending downward into the top side of the main body and being adjacent to the through bore such that an inner deformable portion is formed between the inner deformation space and the through bore; and
an outer deformation space extending downward into the top side of the main body and being adjacent to an outer wall of the main body such that the outer wall of the main body forms an outer deformable portion corresponding to the outer deformation space.

2. The sealing gasket of claim 1, wherein the inner deformable portion has an inclined side corresponding to the inner deformation space, and a top end of the inclined side of the inner deformable portion is closer to a central axis of the main body than is a bottom end of the inclined side of the inner deformable portion.

3. The sealing gasket of claim 2, wherein the inner deformation space has a top end wider than a bottom end of the inner deformation space.

4. The sealing gasket of claim 3, wherein the inner deformable portion has a top end thinner than a bottom end of the inner deformable portion.

5. The sealing gasket of claim 1, wherein the outer deformable portion has an inclined side facing away from the outer deformation space, and a top end of the inclined side of the outer deformable portion is farther away from a central axis/the central axis of the main body than is a bottom end of the inclined side of the outer deformable portion.

6. The sealing gasket of claim 2, wherein the outer deformable portion has an inclined side facing away from the outer deformation space, and a top end of the inclined side of the outer deformable portion is farther away from a central axis/the central axis of the main body than is a bottom end of the inclined side of the outer deformable portion.

7. The sealing gasket of claim 3, wherein the outer deformable portion has an inclined side facing away from the outer deformation space, and a top end of the inclined side of the outer deformable portion is farther away from a central axis/the central axis of the main body than is a bottom end of the inclined side of the outer deformable portion.

8. The sealing gasket of a claim 4, wherein the outer deformable portion has an inclined side facing away from the outer deformation space, and a top end of the inclined side of the outer deformable portion is farther away from a central axis/the central axis of the main body than is a bottom end of the inclined side of the outer deformable portion.

9. The sealing gasket of claim 5, wherein the outer deformation space has a top end wider than a bottom end of the outer deformation space.

10. The sealing gasket of claim 6, wherein the outer deformation space has a top end wider than a bottom end of the outer deformation space.

11. The sealing gasket of claim 7, wherein the outer deformation space has a top end wider than a bottom end of the outer deformation space.

12. The sealing gasket of claim 8, wherein the outer deformation space has a top end wider than a bottom end of the outer deformation space.

13. The sealing gasket of claim 9, wherein the main body is peripherally provided with an engaging portion adjacent to the bottom side of the main body, and the engaging portion is engageable with the cup-shaped structure.

14. The sealing gasket of claim 10, wherein the main body is peripherally provided with an engaging portion adjacent to the bottom side of the main body, and the engaging portion is engageable with the cup-shaped structure.

15. The sealing gasket of claim 11, wherein the main body is peripherally provided with an engaging portion adjacent to the bottom side of the main body, and the engaging portion is engageable with the cup-shaped structure.

16. The sealing gasket of claim 12, wherein the main body is peripherally provided with an engaging portion adjacent to the bottom side of the main body, and the engaging portion is engageable with the cup-shaped structure.
